(19) United States
(12) Patent Application Publication
(10) Pub. No.: US 2018/0364713 A1
(43) Pub. Date: Dec. 20, 2018

(54) DRONE CONTROL SYSTEM

(71) Applicant: International Business Machines Corporation, Armonk, NY (US)

(72) Inventors: Clyde Foster, II, Raleigh, NC (US); Jhansi R. Kolla, Morrisville, NC (US); Joseph Kozhaya, Morrisville, NC (US); Karl D. McCormick, II, Raleigh, NC (US)

(21) Appl. No.: 15/624,836

(22) Filed: Jun. 16, 2017

(51) Int. Cl. G05D 1/00; G05D 1/10; G08G 5/00; B64C 39/02

(52) U.S. Cl. CPC G05D 1/0088; G05D 1/104; B64C 2201/141; B64C 39/024; B64C 2201/128; G08G 5/0034

(57) ABSTRACT

A drone control system is communicatively coupled to a plurality of drones. A drone from the plurality drones is selected to travel to a destination site. Predefined rules associated with airspace over public and private areas may be generated and stored. A route is generated for the drone to travel based on an airspace map. Based on one or more constraints over the route specified in the predefined rules, path height is determined. The route is loaded onto drone and the drone is controlled to fly via the route according to the path height to the destination site. The drone's flight is monitored and a signal is received from the drone that the drone completed its travel to the destination site.

### FIELD

The present application relates generally to computers and computer applications, and more particularly to controlling unmanned aerial vehicles, their navigation and traffic.

### BACKGROUND

Drones are small, lightweight aerial vehicles that are operated either autonomously by onboard computers or by a human operator via remote control. For autonomous flight, drones contain a global positioning system (GPS) device that guides them along a sequence of waypoints or intermediate places on a line of travel, and enables them to return to their launching point. Drones may carry payloads, such as sensor packages, cameras, or other types of small objects. The flight time of a drone is a function of its weight, battery capacity, and operating environment such as wind.

Drones are becoming increasingly popular in the hobbyist/consumer market. Interest in the commercial use of drones is also increasing, as new regulations in the U.S. are being crafted to enable commercial drone flights. Industries that drones may impact may include agriculture, cinematography, mining, oil and gas, emergency response, and law enforcement.

### BRIEF SUMMARY

A drone control system and method of controlling a drone are provided. A drone control system, in one aspect, may include at least one hardware processor communicatively coupled to a plurality of drones, the hardware processor selecting a drone from the plurality drones to travel to a destination site. A storage device may be coupled to the hardware processor and stores predefined rules associated with airspace over public and private areas. The hardware processor may generate a route for the drone to travel based on an airspace map, accessing the storage device to determine one or more constraints over the route specified in the predefined rules. The hardware processor may determine path height over the route based on the constraints in generating the route. The hardware processor may load the route onto a memory associated with the drone, and control the drone to fly via the route, for example, and according to the path height to the destination site. The hardware processor may monitor a flight of the drone and receive a signal from the drone that the drone completed its travel to the destination site.

A method of controlling a drone, in one aspect, may include selecting a drone from a plurality drones to travel to a destination site. The method may also include retrieving from a storage device coupled to the hardware processor, predefined rules associated with airspace over public and private areas. The method may further include generating a route for the drone to travel based on an airspace map, for example, including determining from the predefined rules one or more constraints over the route and determining path height over the route based on the constraints. The method may further include loading the route onto a memory associated with the drone, and controlling the drone to fly via the route, for example, including according to the path height to the destination site. The method may also include monitoring a flight of the drone and receiving a signal from the drone that the drone completed its travel to the destination site.

A computer readable storage medium storing a program of instructions executable by a machine to perform one or more methods described herein also may be provided.

Further features as well as the structure and operation of various embodiments are described in detail below with reference to the accompanying drawings. In the drawings, like reference numbers indicate identical or functionally similar elements.

### BRIEF DESCRIPTION OF THE DRAWINGS

FIG. 1 is a diagram illustrating a method of the present disclosure in one embodiment that controls drones in air space.

FIG. 2 is a diagram illustrating system components in one embodiment of the present disclosure.

FIG. 3 illustrates a schematic of an example computer or processing system that may implement a drone control system in one embodiment of the present disclosure.

### DETAILED DESCRIPTION

Drones are also referred as unmanned aerial vehicle (UAV). The terms drone and UAV are used interchangeably throughout the description. Areas a drone can fly or travel may be generally limited by local area regulations and practical operating conditions. The present disclosure may provide a predefined route for a drone based on the destination and at the same time taking into account other drones in the same vicinity at the same time. The predefined route may be determined according to the drone's size and its capacity, air traffic controllers, and one or more requirements of an entity that is employing or dispatching the drone.

Currently, no specific fly zones exist for drones. With increasing commercialization of drones within urban areas, access to airspace above private property may be required to not only allow the delivery of packages but also for the efficient and safe drone transit from point A to point B. Specific air corridors may need to be established that are dynamic in nature, allowing a drone to transit both public corridors that are well defined and private corridors that will be dynamic in nature based on a private residence defined rules.

Zones may include specification of policies based on a business requirement, specific model or type of the drone, capacity, time of day, altitude, cargo, and geographic location and may require a navigation system that takes these parameters into account when navigating a route.

Examples of private residence policies may include the following. One example may include a private residence setting a policy that allows no drone traffic at all except on days when a package is scheduled to be delivered. For example, on a day when a package is scheduled to be delivered, and only after prior authorization from a residence, a merchant may submit a policy change to a specific residence allowing drone delivery, opening that airspace to drone traffic for deliver, but not flyover. Another example of private residence policies may include a residence allowing a fly-over during normal working hours, but no flyover in the morning or evenings. Yet another example may include restricting by a home owners association (HOA) rules associated with a cluster of residences. For instance, HOA policies may require multiple adjoining landowners to agree for flyover over that neighborhood before opening a corridor. Such information may be input to a system of the present disclosure, for example, via web site page entry, automatic authorization based on an e-commerce interaction, publish-subscribe (pub-sub) messaging where each authorized entity publishes the status of its airspace and each delivery entity subscribes to the status of airspaces it may need, or another, by those who are authorized to do so

Similar to aircraft, an air traffic controller may be provided to control the drone traffic. Unlike aircraft, however, a large portion of a Drone Air Traffic Control (DATC) system is automated with respect to flight path selection and in-route navigation. Based on the predefined destination and polices for flyover between the originating point and the destination, DATC provides the route for navigation for any drone before it starts. While flying, drones communicate both with DATC and with other drones within the area to ensure a safe zone around each drone. If a safe zone is intruded upon, DATC notifies both drones about the situation and re-routes one of the drones. A re-route may include a new route with the shortest new path or an altitude adjustment to the existing route (original route being rerouted) to ensure safe passage. DATC actively monitors all traffic and alerts operators if needed.

In one embodiment, priority is assigned to traffic. This can be used both for emergency situations and for “one hour” delivery of merchandise (e.g., a delivery that takes a specific amount of time). In one embodiment, DATC gives the priority for all emergency vehicles. Drones with lower priority are notified about higher priority traffic and routed accordingly. In case of any fire or any incoming weather conditions, DATC notifies all the drones under its controlled area. At the same time, responsive to detecting any emergency associated with a drone within itself (e.g., machine malfunction), the drone may relay emergency information via signaling to the DATC and all nearby drones to take an immediate action. In one embodiment, a common collaboration infrastructure is provided between the drone and other drones to collaborate with each other. Such structure and restrictions provide drones to fly in a convenient manner.

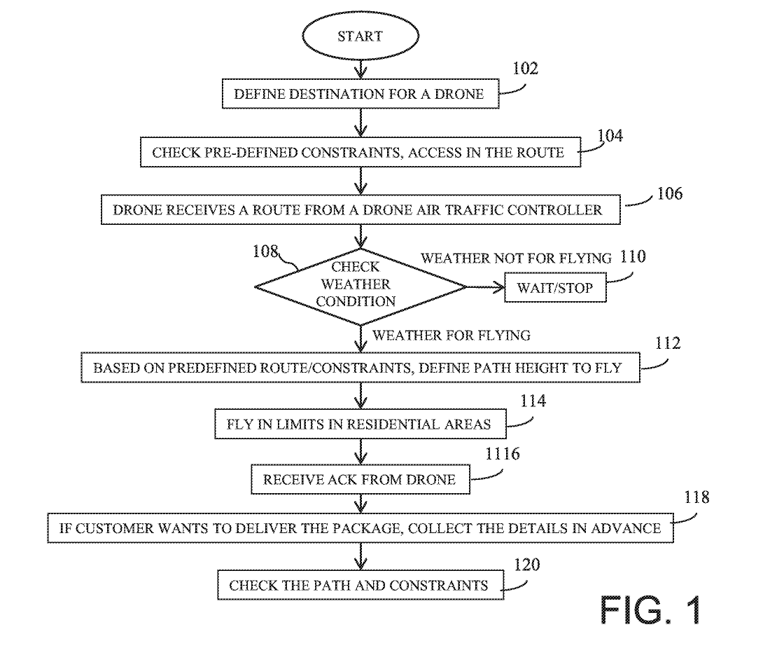

FIG. 1 is a diagram illustrating a method of the present disclosure in one embodiment that controls drones in air space. Fly zone rules may be generated to define rules that specify how a drone may fly over an area. These pre-defined rules may be accessed before dispatching a drone to an area, for example, to deliver a package. The fly zone rules may be generated, for example, by obtaining prior permission from property residents on the ground (e.g., HOA) of the area so that drone can fly in that area. In one aspect, compensation may be given to the residents for allowing the drone in their neighborhood. Areas that are in public areas (e.g., government-owned or non-private), permission may be obtained from the appropriate authority (e.g., government) and airspace permission to public and private properties may be defined. Maps may be generated that define routes, for example, including obstructions, height restrictions, speed limits, and cargo limitations. Such information may be obtained by accessing one or more databases that store the information and/or by receiving as input via a user interface such as a web site page or an automatic publish-subscribe messaging platform. The fly zone rules may also include recipient specified receiving areas such as a flat landing area or a device that directs a drone to a cargo receptacle. The drone may be loaded with instructions to initiate a hand-shake protocol when it is within a predefined distance of the target destination. This hand-shake protocol allows local cargo receptacle devices to communicate with the drone and send it instructions to direct it to delivery zone. Such fly zone rules may be defined for a plurality of areas or zones.

At 102, a destination for a drone may be defined. For instance, a retailer or another entity may employ a drone to deliver a package to a recipient of the package, for example, to a destination site. An example of a destination is a property or home address of the recipient.

A flight plan may be generated based on current airspace maps and policies, type and size of drone, and type of cargo. At 104, a predefined fly zone rules may be retrieved to determine delivery information associated with the destination site. For example, the fly zone rules may include constraints such as the time frame during which a package can be delivered to the destination site, and other rules specified and approved by the recipient and/or the property's owner. Other information accessed from the predefined fly zone rules may include determining any public and/or private corridor along the route. The drone air traffic controller can employ one of several navigation optimization techniques to provide the best route for the drone. In one embodiment, the drone air traffic controller models the airspace corridors as edges in a graph and the intersections of various airspace corridors as nodes in the graph. The edges are then assigned weights based on the policies governing the various airspace corridors. For example, an airspace corridor over a private residence which has published a status of “denied” would get a very high weight penalizing any suggested route that leverages this corridor. This very high weight can be a predefined number, and is relatively high compared to other assigned weights. The graph may also be truncated to within a threshold distance surrounding the route source and target destination of the drone. Once this graph model is created with the various restrictions of allowed travel based on policies, the controller can apply a shortest path optimization solution to find the shortest path (least weight) for the drone to go from the source to the target destination. The result of the shortest path optimization is a set of airspace corridors to be followed by the drone in its route from source to target.

At 106, a drone air traffic controller transmits a route to the drone, and the drone receives the route.

At 108, weather condition in the route is checked. For example, the weather condition may be determined by communicating with a computer server that provides weather information, such as a weather channel web site server. If the weather condition is determined to be hazardous for flying, drone's flight is suspended at 110. For example, if the temperature of the area of the route is outside of threshold range of temperatures and/or any occurrence of storms in the route is detected, the weather condition may be determined to be problematic for flying the drone. In one embodiment, the drone air traffic controller connects to a weather service in the cloud computing environment such as the weather underground service to look up the weather conditions. The drone air traffic controller may then decide whether the weather conditions are satisfactory for the drone's trip based on a set of rules. Such rules can be manually coded by reviewing historical data for failures or can be statistically obtained by using predictive machine learning techniques.

At 112, if the weather condition calls for safe flying condition, based on predefined route and constraints in that route, the path height may be defined. Path height of the drone allows for adhering to policies such as flyover over a regulated area such as a private residence. Additionally, assuming the weather conditions are detailed, the path height of the drone may function as an optimization parameter to include as wind speed and direction can affect a drone's range and changes in wind dynamics need to be addressed by adjusting the flight path for the drone. Weather conditions and policy requirements may be represented as weights on the edges of the graph to be considered during the optimization problem of finding shortest path from source to destination.

At 114, the determined flight path adjusted based on the constraints and including the path height is loaded into the drone, for example, loaded into the drone's memory and controls the drone to fly. In one embodiment, loading the flight path unto the drone is fulfilled by initiating a communication channel between the drone and the drone air traffic controller using a wireless communication channel. After an initial handshake and authentication between the drone and the air traffic controller, the optimized flight path is downloaded to the drone via the secure wireless communication channel between drone and air traffic controller. Based on the loaded flight path, the drone travels (flies) over the route. Flight is monitored. For example, the air traffic controller or controlling system monitors the drone's flight, in relation to weather and other drones and vehicles in the area of the flight path. A wireless channel similar to that used to load the flight path is used to monitor the drone's flight. Speed, time, altitude, and health are transmitted to drone air traffic control at specified intervals. This information can be used not only to ensure that the drone stays within an authorized flight corridor, but also to ensure adequate separation between drones, to adjust a flight path based on changing weather conditions, to detect mechanical issues that may affect the drones availability for future deliveries once it returns, and to allow real-time updates to customers as to the status of their package.

At 116, once the drone arrives at the destination site, and the recipient receives the package, the recipient may signal an acknowledgment message (ACK) to the controller that is administering or monitoring the drone. The controller receives that message.

At 118, it is determined whether a package is available at the destination site for a pickup to a new destination (e.g., for delivery to another location). Such methodology may facilitate two-way deliveries, for example, deliver to and also pickup packages at the same destination site. In this way, drone usage is optimized.

At 120, the path and constraints of the new delivery destination may be checked, for example, as at 106, and the logic of the method may continue to 112 to iterate the delivery processing.

In one embodiment, a controller system of the present disclosure controls the drones to travel to their destination (and, for example, back to their original launching point or another point) based on the generated predefined rules.

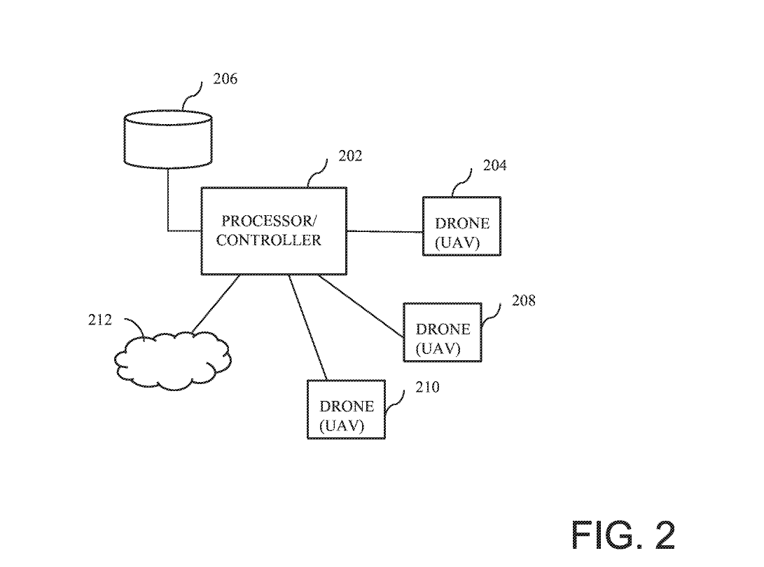

FIG. 2 is a diagram illustrating system components in one embodiment of the present disclosure. A controller or a control system that controls the drones and their routes and navigation may be run on one or more hardware processor. The controller 202 may select a drone to travel to a destination site. The controller 202, for example, responsive to receiving instructions to dispatch a drone (e.g., from a retailer's server that is fulfilling its delivery request), defines a destination and a flight plan for the drone, for example, based on current airspace maps and policies, type and size (and/or weight) of drone, and type of cargo. The controller 202 transmits the route to a drone 204 assigned to this delivery.

In one embodiment, the controller checks the predefined rules stored in a database 206, which include constraints of the route. As described above, the constraints include private and/or public rules of flying a drone along the route. The controller 202 also checks the current weather condition (e.g., weather condition during the anticipated period of the drone's travel). If the controller 202 determines that the weather condition would affect the drone's operating (flying) ability, the drone is not dispatched at this time. The weather condition may be determined based on accessing weather information, for example, over a network 212, such as the Internet, or communicating directly with weather servers, for example, over the network 212. Otherwise, the controller 202, based on the predefined rules or constraints and the route, defines or computes the path height of the drone to fly. The controller 202 may also take into account other drones (e.g., 208, 210) flying or operating in the area of the route. The controller 202 takes into consideration those factors in generating the route or the flight plan. The controller 202 then controls the drone 204 to fly or travel according to the route and the flying height. The controller 202 monitors the drone's (204) flight, and may receive and acknowledgment signal from the drone that it has completed its delivery assignment. The controller 202 may also direct or control the drone 204 to pick up another package from that destination, for example, if such pick up has been planned. If a pickup has been planned, the size, weight, and contents of the package are determined beforehand to ensure that the drone delivering a package is of adequate size to pick-up the return package. Alternatively, if a priority request came in, the drone air traffic control may analyze the availability of drones in the area, through a wireless communications channel send it a path update that would take the drone to the second location as well as a return path from the second location. Once at the second location there communication may be established between a portal and the drone to identify the drone and which package should be picked-up by that drone. The portal may then make the package available to the drone for pick-up. Once the drone has secured the package, it follows the return path.

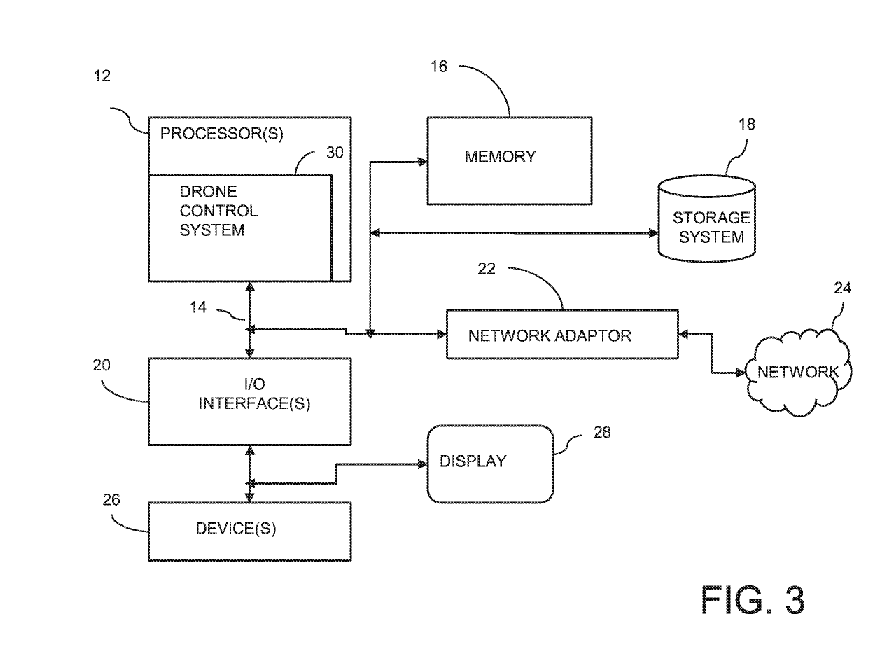

FIG. 3 illustrates a schematic of an example computer or processing system that may implement a drone control system in one embodiment of the present disclosure. The computer system is only one example of a suitable processing system and is not intended to suggest any limitation as to the scope of use or functionality of embodiments of the methodology described herein. The processing system shown may be operational with numerous other general purpose or special purpose computing system environments or configurations. Examples of well-known computing systems, environments, and/or configurations that may be suitable for use with the processing system shown in FIG. 3 may include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

The computer system may be described in the general context of computer system executable instructions, such as program modules, being executed by a computer system. Generally, program modules may include routines, programs, objects, components, logic, data structures, and so on that perform particular tasks or implement particular abstract data types. The computer system may be practiced in distributed cloud computing environments where tasks are performed by remote processing devices that are linked through a communications network. In a distributed cloud computing environment, program modules may be located in both local and remote computer system storage media including memory storage devices.

The components of computer system may include, but are not limited to, one or more processors or processing units 12, a system memory 16, and a bus 14 that couples various system components including system memory 16 to processor 12. The processor 12 may include a module 30 that performs the methods described herein. The module 30 may be programmed into the integrated circuits of the processor 12, or loaded from memory 16, storage device 18, or network 24 or combinations thereof.

Bus 14 may represent one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system may include a variety of computer system readable media. Such media may be any available media that is accessible by computer system, and it may include both volatile and non-volatile media, removable and non-removable media.

System memory 16 can include computer system readable media in the form of volatile memory, such as random access memory (RAM) and/or cache memory or others. Computer system may further include other removable/non-removable, volatile/non-volatile computer system storage media. By way of example only, storage system 18 can be provided for reading from and writing to a non-removable, non-volatile magnetic media (e.g., a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 14 by one or more data media interfaces.

Computer system may also communicate with one or more external devices 26 such as a keyboard, a pointing device, a display 28, etc.; one or more devices that enable a user to interact with computer system; and/or any devices (e.g., network card, modem, etc.) that enable computer system to communicate with one or more other computing devices. Such communication can occur via Input/Output (I/O) interfaces 20.

Still yet, computer system can communicate with one or more networks 24 such as a local area network (LAN), a general wide area network (WAN), and/or a public network (e.g., the Internet) via network adapter 22. As depicted, network adapter 22 communicates with the other components of computer system via bus 14. It should be understood that although not shown, other hardware and/or software components could be used in conjunction with computer system. Examples include, but are not limited to: microcode, device drivers, redundant processing units, external disk drive arrays, RAID systems, tape drives, and data archival storage systems, etc.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

We claim:

1. A drone control system, comprising:
at least one hardware processor communicatively coupled to a plurality of drones, the hardware processor selecting a drone from the plurality drones to travel to a destination site;
a storage device coupled to the hardware processor and storing predefined rules associated with airspace over public and private areas;
the hardware processor generating a route for the drone to travel based on an airspace map, the hardware processor accessing the storage device to determine one or more constraints over the route specified in the predefined rules;
the hardware processor loading the route onto a memory associated with the drone, and controlling the drone to fly via the route to the destination site;
the hardware processor monitoring a flight of the drone and receiving a signal from the drone that the drone completed its travel to the destination site.

2. The drone control system of claim 1, wherein the hardware processor further determines whether the drone is to make another travel from the destination site to a another destination site, and routes the drone to said another destination.

3. The drone control system of claim 1, wherein the hardware processor determines weather conditions along the route, and based on the weather conditions, the hardware processor controls the drone to fly.

4. The drone control system of claim 1, wherein the predefined rules are generated from specifications received from private owners of property situated along the route.

5. The drone control system of claim 1, wherein the route is generated taking into account the drone's size and the drone's cargo.

6. The drone control system of claim 1, wherein the hardware processor dispatches the drone to deliver a package to the destination site.

7. The drone control system of claim 1, wherein the route is generated taking into account other drones traveling in an area of the route.

8. A method of controlling a drone, the method executed by at least one hardware processor, the method comprising:
selecting a drone from a plurality drones to travel to a destination site;
retrieving from a storage device coupled to the hardware processor, predefined rules associated with airspace over public and private areas;
generating a route for the drone to travel based on an airspace map,
determining from the predefined rules one or more constraints over the route;
determining path height over the route based on the constraints;
loading the route onto a memory associated with the drone, and controlling the drone to fly via the route according to the path height to the destination site; and
monitoring a flight of the drone and receiving a signal from the drone that the drone completed its travel to the destination site.

9. The method of claim 8, further comprising determining whether the drone is to make another travel from the destination site to another destination site, and routing the drone to said another destination.

10. The method of claim 8, further comprising determining weather conditions along the route, and the drone is controlled to fly subject to the weather conditions.

11. The method of claim 8, wherein the predefined rules are generated from specifications received from private owners of property situated along the route.

12. The method of claim 8, wherein the route is generated taking into account the drone's size and the drone's cargo.

13. The method of claim 8, wherein the drone is to deliver a package to the destination site.

14. A computer readable storage device storing a program of instructions executable by a machine to perform a method of controlling a drone, the method comprising:
selecting a drone from a plurality drones to travel to a destination site;
retrieving from a storage device coupled to the hardware processor, predefined rules associated with airspace over public and private areas;
generating a route for the drone to travel based on an airspace map, determining from the predefined rules one or more constraints over the route;
determining path height over the route based on the constraints;
loading the route onto a memory associated with the drone, and controlling the drone to fly via the route according to the path height to the destination site; and
monitoring a flight of the drone and receiving a signal from the drone that the drone completed its travel to the destination site.

15. The computer readable storage device of claim 14, further comprising determining whether the drone is to make another travel from the destination site to another destination site, and routing the drone to said another destination.

16. The computer readable storage device of claim 14, further comprising determining weather conditions along the route, and the drone is controlled to fly subject to the weather conditions.

17. The computer readable storage device of claim 14, wherein the predefined rules are generated from specifications received from private owners of property situated along the route.

18. The computer readable storage device of claim 14, wherein the route is generated taking into account the drone's size and the drone's cargo.

19. The computer readable storage device of claim 14, wherein the drone is to deliver a package to the destination site.

20. The computer readable storage device of claim 14, wherein the route is generated taking into account other drones traveling in an area of the route.
